(19) United States
(12) Patent Application Publication
(10) Pub. No.: US 2025/0346046 A1
(43) Pub. Date: Nov. 13, 2025

(54) LASER SCANNING UNIT AND IMAGE FORMING APPARATUS

(71) Applicant: KYOCERA Document Solutions Inc., Osaka (JP)

(72) Inventor: Kenshin Matsuuchi, Osaka (JP)

(21) Appl. No.: 19/200,091

(22) Filed: May 6, 2025

(30) Foreign Application Priority Data
May 8, 2024 (JP) 2024-075843

(51) Int. Cl. B41J 2/47; B41J 2/44; G02B 26/08; G02B 26/12; G03G 15/04; G03G 15/043

(52) U.S. Cl. CPC B41J 2/471; B41J 2/442; G02B 26/0816; G02B 26/121; G03G 15/04036; G03G 15/0435

(57) ABSTRACT

A cover covers the periphery of a polygon mirror and a motor, and has a detection aperture formed at a specific position around a portion of a rotation shaft where a to-be-detected portion is formed. An reflective optical sensor is disposed outside the cover so as to face the detection aperture. The detection aperture is formed in an area where internally reflected light, which is the beam light reflected toward the inner surface of the cover on each of the plurality of mirror surfaces, can reach after at least two specular reflections on the inner surface of the cover when viewed in an axial direction along the rotation shaft.

### INCORPORATION BY REFERENCE

This application is based upon and claims the benefit of priority from the corresponding Japanese Patent Application No. 2024-075843 filed on May 8, 2024, the entire contents of which are incorporated herein by reference.

### BACKGROUND

The present disclosure relates to a laser scanning unit and an image forming apparatus that include an optical sensor for detecting a to-be-detected portion of a rotation shaft of a polygon mirror.

In an electrophotographic image forming apparatus, a laser scanning unit forms an electrostatic latent image on a surface of a photoconductor by scanning with beam light. The laser scanning unit scans the surface of the photoconductor with the beam light by reflecting the beam light with a polygon mirror.

It is known that the laser scanning unit includes a reflective optical sensor disposed in the vicinity of the polygon mirror, and a light receiving element for detecting beam light reflected by the polygon mirror.

### SUMMARY

A laser scanning unit according to an aspect of the present disclosure includes a light source, a polygon mirror, a motor, a cover, a reflective optical sensor, and a light receiving element. The light source emits beam light. The polygon mirror includes a rotation shaft with a portion in a circumferential direction where a to-be-detected portion is formed; and a plurality of mirror surfaces configured to reflect the beam light emitted from the light source, and is rotatable about the rotation shaft; The motor rotates the rotation shaft. The cover covers the periphery of the polygon mirror and the motor, and has a detection aperture formed at a specific position around the portion of the rotation shaft where the to-be-detected portion is formed and a scanning aperture formed in a specific range including an incident path of the beam light around the plurality of mirror surfaces. The reflective optical sensor is disposed outside the cover so as to face the detection aperture, and emits detection light toward the rotation shaft through the detection aperture and detects reflected light of the detection light. The light receiving element is disposed outside the cover, and detects scanning beam light, which is the beam light sent for scanning through the scanning aperture by being reflected by each of the plurality of mirror surfaces. The detection aperture is formed in an area where internal reflection light that is beam light reflected toward an inner surface of the cover on each of the plurality of mirror surfaces, can reach after at least two specular reflections on the inner surface of the cover when viewed in an axial direction along the rotation shaft.

A laser scanning unit according to another aspect of the present disclosure includes the light source, the polygon mirror, the motor, a cover, the reflective optical sensor, and the light receiving element. The cover covers the periphery of the polygon mirror and the motor, and has a detection aperture formed at a specific location around the part of the rotation shaft where the to-be-detected portion is formed and a scanning aperture formed in a specific range including an incident path of the beam light around the plurality of mirror surfaces. The detection aperture is formed in an area upstream in a rotation direction of the rotation shaft of a position where an extension of a straight line from a light emitting portion of the light source to a center of the rotation shaft intersects an inner surface of the cover when viewed along an axial direction along the rotation shaft.

An image forming apparatus according to another aspect of the present disclosure includes a photoconductor, the laser scanning unit configured to form an electrostatic latent image on a surface of the photoconductor by scanning a surface of the photoconductor with the beam light, and a control portion. The control portion identifies a target mirror surface sending the scanning beam light through the scanning aperture among the plurality of mirror surfaces in accordance with a detection result of the reflective optical sensor, and controls turning on and off of the light source in accordance with a result of identifying the target mirror surface and a detection result of the light receiving element.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a plan view of the inside of a laser scanning unit in the image forming apparatus according to the embodiment.

FIG. 3 is a plan sectional view of a peripheral portion of a polygon mirror in the laser scanning unit of the image forming apparatus according to the embodiment.

FIG. 4 shows the relationship between the path of internally reflected light and the position of a detection aperture in the laser scanning unit of the image forming apparatus according to the embodiment.

FIG. 5 shows the positional relationship between a light source, the polygon mirror, and the detection aperture in the laser scanning unit of the image forming apparatus according to the embodiment.

FIG. 6 is a side view of the inside of a mirror cover in the laser scanning unit of the image forming apparatus according to the embodiment.

FIG. 7 is a side view of the mirror cover in the laser scanning unit of the image forming apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

An image forming apparatus 10 according to the embodiment executes print processing using an electrophotographic method. The print processing is processing for forming an image on a sheet 9. The sheet 9 is an image forming medium such as paper or a sheet-like resin member.

### [Configuration of Image Forming Apparatus 10]

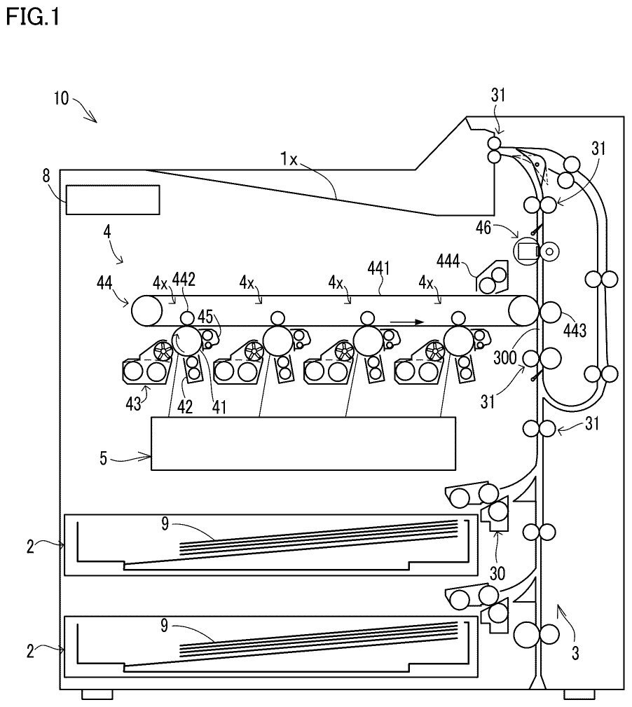

As shown in FIG. 1, the image forming apparatus 10 includes a sheet conveying device 3, a printing device 4, and a control device 8.

The sheet conveying device 3 includes a sheet feeding mechanism 30, and a plurality of conveying roller pairs 31. The sheet feeding mechanism 30 feeds a sheet 9 stored in a sheet storing portion 2 to a conveying path 300. The conveying path 300 is a passage through which the sheet 9 is conveyed.

The plurality of conveying roller pairs 31 rotate to convey the sheet 9 along the conveying path 300, and further discharges the sheet 9 to a discharge tray 1x.

The printing device 4 performs the print processing using an electrophotographic method. The printing device 4 includes one or more image forming portions 4x, a laser scanning unit 5, a transfer device 44, and a fixing device 46.

In the example shown in FIG. 1, the image forming apparatus 10 is a tandem-type color image forming apparatus. Therefore, the printing device 4 includes a plurality of image forming portions 4x corresponding to a plurality of developing colors.

The image forming portions 4x each include a drum-shaped photoconductor 41, a charging device 42, a developing device 43, a drum cleaning device 45, and the like. That is, the printing device 4 includes a plurality of photoconductors 41, a plurality of developing devices 43, and a plurality of drum cleaning devices 45 corresponding to a plurality of toner colors.

In each of the image forming portions 4x, the photoconductor 41 rotates, and the charging device 42 charges the surface of the photoconductor 41. The laser scanning unit 5 scans the charged surfaces of the photoconductors 41 with beam light. Thus, the laser scanning unit 5 forms an electrostatic latent image on the surface of each of the photoconductors 41. For example, the beam light is a laser beam.

In each of the image forming portions 4x, the developing device 43 supplies toner to the surface of the photoconductor 41 to develop the electrostatic latent image into a toner image. The toner is a granular developer. The photoconductor 41 is an example of an image carrier that rotates while carrying the toner image.

In the present embodiment, the printing device 4 includes four image forming portions 4x corresponding to the toners of four developing colors: yellow, cyan, magenta, and black. Accordingly, the printing device 4 includes four photoconductors 41, four developing devices 43, and four drum cleaning devices 45.

Four toner images are formed on the surfaces of the four photoconductors 41. The transfer device 44 transfers the four toner images from the four photoconductors 41 to the sheet 9.

The transfer device 44 includes an intermediate transfer belt 441, four primary transfer devices 442 corresponding to the four image forming portions 4x, a secondary transfer device 443, and a belt cleaning device 444.

The four primary transfer devices 442 transfer the toner images on the surfaces of the four photoconductors 41 to the surface of the intermediate transfer belt 441. Thus, a composite color toner image obtained by combining the toner images of the four photoconductors 41 is formed on the surface of the intermediate transfer belt 441.

The secondary transfer device 443 transfers the color toner image formed on the intermediate transfer belt 441 to the sheet 9 at a transfer position of the conveying path 300.

The fixing device 46 heats and presses the color toner image transferred to the sheet 9. Thus, the fixing device 46 fixes the color toner image on the sheet 9.

Each drum cleaning device 45 removes toner remaining on the surface of the corresponding photoconductor 41. The belt cleaning device 444 removes the toner remaining on the intermediate transfer belt 441.

The control device 8 executes various types of data processing and control of devices such as the sheet conveying device 3 and the printing device 4.

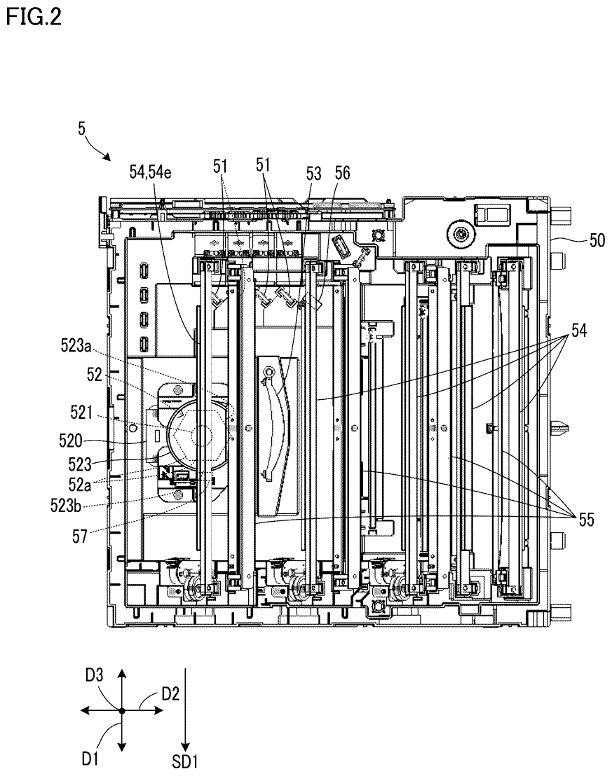

As shown in FIG. 2, the laser scanning unit 5 includes a housing 50, one or more light sources 51, a polygon mirror 52, and a motor substrate 520. The motor substrate 520 is a substrate on which a polygon motor 521 for rotating a rotation shaft 52b of the polygon mirror 52 is mounted.

The laser scanning unit 5 further includes a main lens 53, one or more long mirrors 54, and one or more sub lenses 55. The housing 50 is a molded member made of synthetic resin.

In the present embodiment, the laser scanning unit 5 includes at least four light sources 51, at least four long mirrors 54, and at least four sub lenses 55 corresponding to the four photoconductors 41, respectively.

The light sources 51, the polygon mirror 52, the motor substrate 520, the main lens 53, the long mirrors 54, and the sub lenses 55 are disposed in the housing 50.

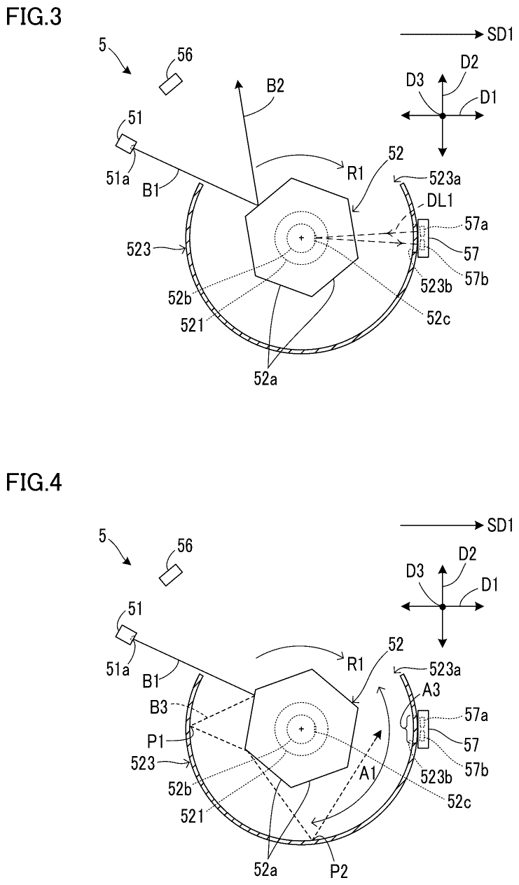

Each of the light sources 51 emits beam light B1 (see FIG. 3). In the present embodiment, each of the light sources 51 is a laser light source that emits laser light.

The polygon mirror 52 rotates to perform scanning while reflecting the beam light B1 emitted from each of the light sources 51. The polygon mirror 52 sends the reflected light of the beam light B1 along the first direction D1 for scanning.

The polygon mirror 52 has a plurality of mirror surfaces 52a arranged in a regular polygonal shape in the circumferential direction and the rotation shaft 52b (see FIG. 2, FIG. 3, and FIG. 6). Each of the mirror surfaces 52a reflects the beam light B1 emitted from the light source 51.

In the examples shown in FIG. 3 to FIG. 5, the polygon mirror 52 has six mirror surfaces 52a arranged in a regular hexagonal shape. The polygon mirror 52 may have four mirror surfaces 52a arranged in a square shape.

The polygon motor 521 rotates the rotation shaft 52b of the polygon mirror 52. Thus, the polygon mirror 52 rotates about the rotation shaft 52b.

In the following description, the beam light B1 sent for scanning along the first direction D1 by being reflected by each of the plurality of mirror surfaces 52a will be referred to as scanning beam light B2 (see FIG. 3). The scanning direction SD1 of the scanning beam light B2 is a direction from one side to the other side of the first direction D1.

The main lens 53, the plurality of long mirrors 54, and the plurality of sub lenses 55 are each mounted in the housing 50 with the first direction D1 as the longitudinal direction. That is, the main lens 53, the plurality of long mirrors 54, and the plurality of sub lenses 55 are each disposed in the housing 50 along the first direction D1.

In each of the drawings, the axial direction D3 is a direction along the rotation shaft 52b of the polygon mirror 52. For example, the axial direction D3 is a vertical direction or a direction that forms an acute angle with respect to the vertical direction. In addition, the second direction D2 is a direction orthogonal to the first direction D1 when viewed along the axial direction D3. The first direction D1 and the second direction D2 are directions that intersect the axial direction D3.

The scanning beam light B2 passes through the main lens 53 and is further reflected by the long mirrors 54 and passes through the sub lenses 55. The main lens 53 is an fθ lens common to the four developing colors. The sub lenses 55 are fθ lenses corresponding to the four developing colors.

The scanning beam B2 reaches the surfaces of the photoconductors 41 via the main lens 53, the long mirrors 54, and the sub lenses 55.

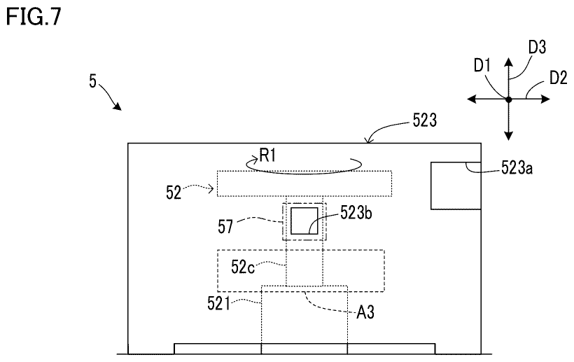

By the way, the laser scanning unit 5 includes a mirror cover 523 that covers the periphery of the polygon mirror 52 and the polygon motor 521 which rotates the polygon mirror 52 (see FIG. 2, FIG. 3, FIG. 6, and FIG. 7).

The mirror cover 523 prevents hot air generated by the heat generation of the polygon motor 521 and the rotation of the polygon mirror 52 from flowing unevenly to a part of the inside of the laser scanning unit 5. That is, the mirror cover 523 prevents the unbalanced temperature distribution caused by the hot air in the laser scanning unit 5.

By suppressing the unbalance of the temperature distribution in the housing 50, the unbalance of the distribution of the thermal expansion of the housing 50 and the optical device in the housing 50 is suppressed. As a result, deterioration in the accuracy of scanning with the scanning beam light B2 due to the distribution of the thermal expansion is suppressed.

In addition, the laser scanning unit 5 includes an optical sensor 57 for detecting a to-be-detected portion 52c formed on the rotation shaft 52b of the polygon mirror 52 (see FIG. 2 and FIG. 3). The to-be-detected portion 52c is formed on a part of the rotation shaft 52b in the circumferential direction (see FIG. 3 and FIG. 6). The optical sensor 57 is a reflective optical sensor including a light emitting portion 57a and a photoelectric conversion element 57b.

The light emitting portion 57a emits detection light DL1 toward the rotation shaft 52b. The photoelectric conversion element 57b detects reflected light of the detection light DL1. The to-be-detected portion 52c has a different light reflection characteristic compared to the other portion in the circumferential direction of the rotation shaft 52b.

For example, the to-be-detected portion 52c is a mirror surface having a higher light reflectance than the other portion in the circumferential direction of the rotation shaft 52b. In this case, it is considered that the portion of the rotation shaft 52b other than the to-be-detected portion 52c is a black surface.

In addition, the to-be-detected portion 52c may be a black surface having a lower light reflectance than the other portion in the circumferential direction of the rotation shaft 52b. In this case, it is considered that the portion of the rotation shaft 52b other than the to-be-detected portion 52c is a mirror surface.

The mirror cover 523 has a scanning aperture 523a and a detection aperture 523b (see FIG. 3, FIG. 6, and FIG. 7). The scanning aperture 523a is formed in a specific range including the incident path of the beam light B1 around the plurality of mirror surfaces 52a. Each of the plurality of mirror surfaces 52a reflects the beam light B1 to send, for scanning, the scanning beam light B2 through the scanning aperture 523a.

The detection aperture 523b is formed at a specific position around a portion of the rotation shaft 52b where the to-be-detected portion 52c is formed.

The optical sensor 57 is disposed outside the mirror cover 523 so as to face the detection aperture 523b. The optical sensor 57 emits the detection light DL1 toward the rotation shaft 52b through the detection aperture 523b and detects the reflected light of the detection light DL1.

The detection result of the optical sensor 57 is used to identify a target mirror surface that is reflecting the scanning beam B2 among the plurality of mirror surfaces 52a of the polygon mirror 52.

In the present embodiment, the control device 8 executes a process of identifying the target mirror surface. The control device 8 includes a processor which realizes the process of identifying the target mirror surface.

Specifically, the control device 8 identifies a to-be-detected portion passing timing in accordance with a change in the detection signal of the optical sensor 57. The to-be-detected portion passing timing is a timing at which the to-be-detected portion 52c passes a position facing the optical sensor 57.

Furthermore, the control device 8 identifies one of the plurality of mirror surfaces 52a as the target mirror surface in a predetermined order according to the elapsed time from the to-be-detected portion passage timing.

The laser scanning unit 5 further includes a light receiving element 56 disposed in the scanning path of the scanning beam B2 outside the mirror cover 523 (see FIG. 2 and FIG. 3). The light receiving element 56 is a photoelectric conversion element for detecting the scanning beam B2.

The control device 8 controls turning on and off of the light source 51 in accordance with the result of identifying the target mirror surface and the detection result of the light receiving element 56.

The control device 8 selects a target parameter corresponding to the target mirror surface from a plurality of lighting parameters corresponding to the mirror surfaces 52a. Each of the lighting parameters is a parameter relating to the control of turning on and off of the light source 51.

Further, the control device 8 controls the timing of turning on and off of the light source 51 in accordance with the detection result of the light receiving element 56, the target parameter, and the data of an output image. It is noted that the control device 8 is an example of the control portion configured to control tuning on and off the light source 51.

When the beam light B1 reflected on each of the mirror surfaces 52a of the polygon mirror 52 reaches the optical sensor 57 after being reflected on the inner surface of the mirror cover 523, the target mirror surface is incorrectly identified. Therefore, in the laser scanning unit 5, it is desired that the optical sensor 57 does not detect the beam light B1 reflected by the polygon mirror 52.

The laser scanning unit 5 has a configuration for preventing erroneous processing due to the beam light B1 reflected by the polygon mirror 52 reaching the optical sensor 57. Hereinafter, the configuration will be described.

In the following description, the beam light B1 reflected by each of the plurality of mirror surfaces 52a of the polygon mirror 52 toward the inner surface of the mirror cover 523 is referred to as internally reflected light B3 (see FIG. 4).

In the laser scanning unit 5, the detection aperture 523b is formed in a first area A1 where the internally reflected light B3 can reach after at least two specular reflections on the inner surface of the mirror cover 523 when viewed along the axial direction D3 (see FIG. 4).

In FIG. 4, the first internal reflection position P1 is the most upstream position in a shaft rotation direction R1 in the area where the internally reflected light B3 can first reach the inner surface of the mirror cover 523. The shaft rotation direction R1 is the rotation direction of the rotation shaft 52b of the polygon mirror 52. That is, the shaft rotation direction R1 is the rotation direction of the polygon mirror 52.

In FIG. 4, the second internal reflection position P2 is the most upstream position in the shaft rotation direction R1 in the area where the specularly reflected light of the internally reflected light B3 on the inner surface of the mirror cover 523 can reach the inner surface of the mirror cover 523 for the second time. The first area A1 is an area upstream of the second internal reflection position P2 in the shaft rotation direction R1 as viewed in the axial direction D3.

The diffusely reflected light of the internally reflected light B3 on the inner surface of the mirror cover 523 is relatively weak. Therefore, even if the diffusely reflected light of the internally reflected light B3 reaches the optical sensor 57 through the detection aperture 523b, it is easy for the optical sensor 57 to distinguish between the reflected light of the detection light DL1 and the diffusely reflected light.

Similarly, the internally reflected light B3 is greatly attenuated by two specular reflections on the inner surface of the mirror cover 523. Therefore, even if the internally reflected light B3 reaches the optical sensor 57 through the detection aperture 523b due to the formation of the detection aperture 523b in the first area A1, it is easy for the optical sensor 57 to distinguish between the reflected light of the detection light DL1 and the internally reflected light B3.

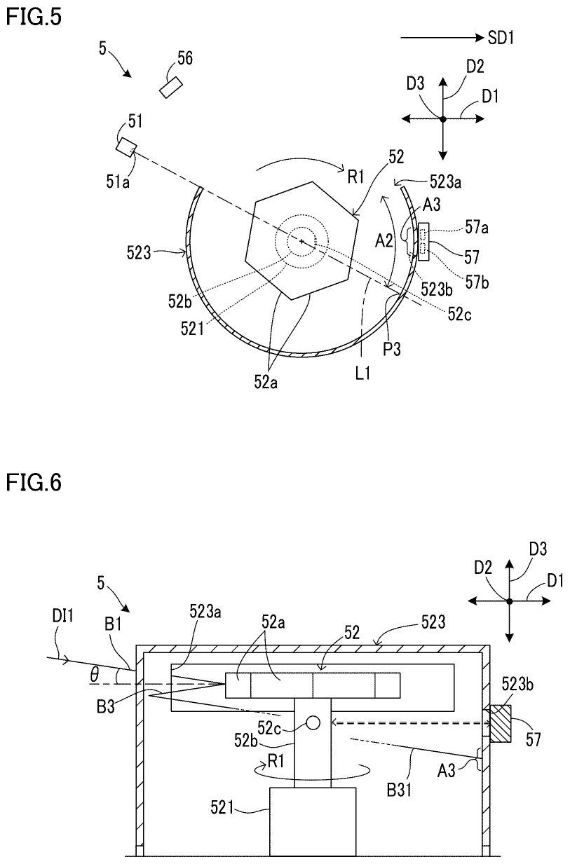

In the following description, an extension of a straight line extending from the light emitting portion 51a of the light source 51 to the center of the rotation shaft 52b of the polygon mirror 52 when viewed along the axial direction D3 will be referred to as a specific straight line L1 (see FIG. 5).

In the present embodiment, the detection aperture 523b is formed in a second area A2 upstream in the shaft rotation direction R1 of an intersection position P3 where the specific straight line L1 intersects the inner surface of the mirror cover 523 as viewed in the axial direction D3 (see FIG. 5).

Also in the case where the detection aperture 523b is formed in the second area A2, the internally reflected light B3 reaches the optical sensor 57 only after being sufficiently attenuated by the reflection on the inner surface of the mirror cover 523. Therefore, with the detection aperture 523b formed in the second area A2, it is easy for the optical sensor 57 to distinguish between the reflected light of the detection light DL1 and the internally reflected light B3.

By employing the laser scanning unit 5, it is possible to prevent erroneous processing for identifying the target mirror surface due to the arrival of the internally reflected light B3 at the optical sensor 57.

In the following description, the emission direction of the beam light B1 by the light source 51 will be referred to as a beam emission direction DI1 (see FIG. 6). The internally reflected light B3 that reaches the inner surface of the mirror cover 523 for the third time after two specular reflections on the inner surface of the mirror cover 523 will be referred to as a twice-reflected light B31 (see FIG. 6). In the laser scanning unit 5, the twice-reflected light B31 is generated.

In the present embodiment, the beam emission direction DI1 is a direction which is oblique in the axial direction D3 with respect to the normal direction of each of the plurality of mirror surfaces 52a. FIG. 6 shows that the beam emission direction DI1 is inclined by the inclination angle θ in the axial direction D3 with respect to the normal direction of each of the plurality of mirror surfaces 52a.

In the present embodiment, the detection aperture 523b is formed in an area outside a third area A3 where the twice-reflected light B31 can reach the inner surface of the mirror cover 523 for the third time when viewed along the direction orthogonal to the axial direction D3 (see FIG. 6 and FIG. 7).

When the range of the incident position of the beam light B1 on each of the mirror surfaces 52a in the axial direction D3 is C1 to C2 and the range of the optical path length of the twice-reflected light B31 originating from each of the mirror surfaces 52a is X1 to X2, the range of the third area A3 in the axial direction D3 is (C1+X1·sin θ to C2+X2·sin θ).

With the detection aperture 523b formed in an area outside the third area A3, erroneous processing for identifying the target mirror surface due to the internally reflected light B3 reaching the optical sensor 57 can be more reliably prevented.

### APPENDIXES OF INVENTION

The following are appendixes to the overview of the invention extracted from the above embodiment. It is noted that the structures and processing functions to be described in the following appendixes can be selected and combined arbitrarily.

### Appendix 1

A laser scanning unit comprising:
a light source configured to emit beam light;
a polygon mirror including: a rotation shaft with a portion in a circumferential direction where a to-be-detected portion is formed; and a plurality of mirror surfaces configured to reflect the beam light emitted from the light source, and rotatable about the rotation shaft;
a motor configured to rotate the rotation shaft;
a cover configured to cover a periphery of the polygon mirror and the motor and including: a detection aperture formed at a specific position around the portion of the rotation shaft where the to-be-detected portion is formed; and a scanning aperture formed in a specific range including an incident path of the beam light around the plurality of mirror surfaces;
a reflective optical sensor disposed outside the cover so as to face the detection aperture and configured to emit detection light toward the rotation shaft through the detection aperture and detect reflected light of the detection light; and
a light receiving element disposed outside the cover and configured to detect scanning beam light, the scanning beam light being the beam light sent for scanning through the scanning aperture by being reflected by each of the plurality of mirror surfaces, wherein
the detection aperture is formed in an area where internally reflected light can reach after at least two specular reflections on an inner surface of the cover when viewed along an axial direction along the rotation shaft, the internally reflected light being the beam light reflected toward the inner surface of the cover on each of the plurality of mirror surfaces.

### Appendix 2

A laser scanning unit comprising:
a light source configured to emit beam light;
a polygon mirror including: a rotation shaft with a portion in a circumferential direction where a to-be-detected portion is formed; and a plurality of mirror surfaces configured to reflect the beam light emitted from the light source, and rotatable about the rotation shaft;
a motor configured to rotate the rotation shaft;
a cover configured to cover a periphery of the polygon mirror and the motor and including: a detection aperture formed at a specific position around the portion of the rotation shaft where the to-be-detected portion is formed; and a scanning aperture formed in a specific range including an incident path of the beam light around the plurality of mirror surfaces;
a reflective optical sensor disposed outside the cover so as to face the detection aperture and configured to emit detection light toward the rotation shaft through the detection aperture and detect reflected light of the detection light; and
a light receiving element disposed outside the cover and configured to detect scanning beam light, the scanning beam light being the beam light sent for scanning through the scanning aperture by being reflected by each of the plurality of mirror surfaces, wherein
the detection aperture is formed in an area upstream in a rotation direction of the rotation shaft of a position where an extension of a straight line from a light emitting portion of the light source to a center of the rotation shaft intersects an inner surface of the cover when viewed along an axial direction along the rotation shaft.

### Appendix 3

The laser scanning unit according to Appendix 1 or 2, wherein
the light source emits the beam light in a direction oblique in the axial direction with respect to a normal direction of each of the plurality of mirror surfaces, and
when, of internally reflected light that is the beam light reflected toward the inner surface of the cover on each of the plurality of mirror surfaces, twice-reflected light after two specular reflections on the inner surface of the cover reaches the inner surface of the cover,
the detection aperture is formed in an area outside an area where the twice-reflected light can reach the inner surface of the cover for a third time when viewed along a direction orthogonal to the axial direction.

### Appendix 4

An image forming apparatus comprising:
a photoconductor;
the laser scanning unit according to any one of Appendixes 1 to 3, the laser scanning unit being configured to form an electrostatic latent image on a surface of the photoconductor by scanning the surface of the photoconductor with the beam light; and
a control portion configured to identify a target mirror surface sending the scanning beam light through the scanning aperture among the plurality of mirror surfaces in accordance with a detection result of the reflective optical sensor, and control turning on and off of the light source in accordance with a result of identifying the target mirror surface and a detection result of the light receiving element.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A laser scanning unit comprising:
a light source configured to emit beam light;
a polygon mirror including: a rotation shaft with a portion in a circumferential direction where a to-be-detected portion is formed; and a plurality of mirror surfaces configured to reflect the beam light emitted from the light source, and rotatable about the rotation shaft;
a motor configured to rotate the rotation shaft;
a cover configured to cover a periphery of the polygon mirror and the motor and including: a detection aperture formed at a specific position around the portion of the rotation shaft where the to-be-detected portion is formed; and a scanning aperture formed in a specific range including an incident path of the beam light around the plurality of mirror surfaces;
a reflective optical sensor disposed outside the cover so as to face the detection aperture and configured to emit detection light toward the rotation shaft through the detection aperture and detect reflected light of the detection light; and
a light receiving element disposed outside the cover and configured to detect scanning beam light, the scanning beam light being the beam light sent for scanning through the scanning aperture by being reflected by each of the plurality of mirror surfaces, wherein
the detection aperture is formed in an area where internally reflected light can reach after at least two specular reflections on an inner surface of the cover when viewed along an axial direction along the rotation shaft, the internally reflected light being the beam light reflected toward the inner surface of the cover on each of the plurality of mirror surfaces.

2. A laser scanning unit comprising:
a light source configured to emit beam light;
a polygon mirror including: a rotation shaft with a portion in a circumferential direction where a to-be-detected portion is formed; and a plurality of mirror surfaces configured to reflect the beam light emitted from the light source, and rotatable about the rotation shaft;
a motor configured to rotate the rotation shaft;
a cover configured to cover a periphery of the polygon mirror and the motor and including: a detection aperture formed at a specific position around the portion of the rotation shaft where the to-be-detected portion is formed; and a scanning aperture formed in a specific range including an incident path of the beam light around the plurality of mirror surfaces;
a reflective optical sensor disposed outside the cover so as to face the detection aperture and configured to emit detection light toward the rotation shaft through the detection aperture and detect reflected light of the detection light; and
a light receiving element disposed outside the cover and configured to detect scanning beam light, the scanning beam light being the beam light sent for scanning through the scanning aperture by being reflected by each of the plurality of mirror surfaces, wherein
the detection aperture is formed in an area upstream in a rotation direction of the rotation shaft of a position where an extension of a straight line from a light emitting portion of the light source to a center of the rotation shaft intersects an inner surface of the cover when viewed along an axial direction along the rotation shaft.

3. The laser scanning unit according to claim 1, wherein
the light source emits the beam light in a direction oblique in the axial direction with respect to a normal direction of each of the plurality of mirror surfaces, and
when, of internally reflected light that is the beam light reflected toward the inner surface of the cover on each of the plurality of mirror surfaces, twice-reflected light after two specular reflections on the inner surface of the cover reaches the inner surface of the cover,
the detection aperture is formed in an area outside an area where the twice-reflected light can reach the inner surface of the cover for a third time when viewed along a direction orthogonal to the axial direction.

4. The laser scanning unit according to claim 2, wherein
the light source emits the beam light in a direction oblique in the axial direction with respect to a normal direction of each of the plurality of mirror surfaces, and
when, of internally reflected light that is the beam light reflected toward the inner surface of the cover on each of the plurality of mirror surfaces, twice-reflected light after two specular reflections on the inner surface of the cover reaches the inner surface of the cover,
the detection aperture is formed in an area outside an area where the twice-reflected light can reach the inner surface of the cover for a third time when viewed along a direction orthogonal to the axial direction.

5. An image forming apparatus comprising:
a photoconductor;
the laser scanning unit according to claim 1, the laser scanning unit being configured to form an electrostatic latent image on a surface of the photoconductor by scanning the surface of the photoconductor with the beam light; and
a control portion configured to identify a target mirror surface sending the scanning beam light through the scanning aperture among the plurality of mirror surfaces in accordance with a detection result of the reflective optical sensor, and control turning on and off of the light source in accordance with a result of identifying the target mirror surface and a detection result of the light receiving element.

6. An image forming apparatus comprising:
a photoconductor;
the laser scanning unit according to claim 2, the laser scanning unit being configured to form an electrostatic latent image on a surface of the photoconductor by scanning the surface of the photoconductor with the beam light; and
a control portion configured to identify a target mirror surface sending the scanning beam light through the scanning aperture among the plurality of mirror surfaces in accordance with a detection result of the reflective optical sensor, and control turning on and off of the light source in accordance with a result of identifying the target mirror surface and a detection result of the light receiving element.
